(19) United States
(12) Patent Application Publication
(10) Pub. No.: US 2010/0233459 A1
(43) Pub. Date: Sep. 16, 2010

(54) METHOD FOR THE PRODUCTION OF A TEXTILE-REINFORCED RIGID FOAM SUPPORT ELEMENT, AND RIGID FOAM SUPPORT ELEMENT

(76) Inventors: Peter Sigmund, Friedberg (DE); Thomas Semlinger, Kissing (DE)

Correspondence Address: FULBRIGHT & JAWORSKI, LLP, 666 FIFTH AVE, NEW YORK, NY, 10103-3198, US

(21) Appl. No.: 12/514,081

(22) PCT Filed: Sep. 7, 2007
(86) PCT No.: PCT/EP07/07807

§ 371 Date: May 11, 2010

(30) Foreign Application Priority Data
Dec. 20, 2006 (DE) 10 2006 060 284.6

(51) Int. Cl. B32B 3/26; B32B 37/16; E04C 2/20

(52) U.S. Cl. 428/304.4; 156/182; 52/309.4

(57) ABSTRACT

The fabric-reinforced rigid foam supporting element claimed having a total thickness of <10 mm is characterized in that it has been produced completely by machine. As a result of the specific features and the preferred production process, supporting elements which have a low thickness and do not differ in terms of their stiffness and strength from supporting elements having thicknesses above 10 mm are obtained. They are therefore outstandingly suitable as insulation materials in building and construction, in particular for constructions, and also for thermal and and/or acoustic insulation.

The present invention relates to a fabric-reinforced rigid foam supporting element, a process for producing it and its use.

Rigid foam supporting elements, also referred to as rigid foam boards, are well known from the prior art. These elements, which generally comprise foamed polystyrene, polyurethane or mixtures thereof, are widely used in building and construction for thermal and/or acoustic insulation.

DE 10 2004 050635 A1 discloses a rigid foam supporting board which is used for accommodating heating pipes of heated screed. This document additionally describes the tools required for producing the channel for the piping and a process for installing heating pipes in these rigid foam supporting boards.

An insulating board composed of rigid foam, which has a particular surface structure for the application of renders, is described in DE 20 2005 02592 U1. DE 4317871 A1 is concerned with similar subject matter:

In this case, the invention relates to construction boards which are provided with a layer of mortar and have marking lines on the surface. These marking lines are formed by the polymer foam boards being provided with grooves and the plates being coated with a suitable mortar so that the grooves are reproduced on the mortar surface due to the shrinkage of the mortar.

Numerous further patent documents are likewise concerned with specific composite boards, processes for producing them and suitable mineral coatings. At this point, mention may be made by way of example of the documents DE 19820595 A1, DE 4242261 A1, DE 4317877 A1, DE 4412149 A1, DE 19548381 A1, DE 19722754 A1, DE 19722755 A1, DE 19820592 A1, DE 19820593 A1 and also the two utility models G 9407270.1 U1 and G 9407732.0 U1.

Especially for internal renovation and interior dry-technique application and here particularly for use in wet areas, boards which are laminated or reinforced with fabric on both sides are common used. The lamination gives the rigid foam boards increased stiffness and thus also a higher intrinsic strength. These boards are therefore well suited for bearing relatively high loads and consequently also for constructions. For example, the installation of supporting elements as walls around bathtubs and shower bases enables the direct tiling or rendering/platering.

Lamination is also carried out using special mortars for fastening or adhesively bonding fabrics onto the rigid foam boards. These mortars are based on hydraulic setting and curing mortar systems, with specific cement mortars generally being used. This type of fabric lamination, inter alia, enables the direct tiling or rendering/platering on the rigid foam supporting elements which have been prepared in this way.

The fabric reinforcement described gives the rigid foam supporting elements a high stiffness, so that they can also be used in thin-wall form, i.e. as boards having a low layer thickness. Particularly in applications in which the construction does not have to meet critical requirements, rigid foam supporting elements having a layer thickness of less than 10 mm are used.

The fabric reinforcement or fabric lamination of rigid foam supporting elements in general have a relatively large thickness if carried out by machine: the rigid foam boards are coated on a conveyor belt by means of a doctor blade system with adhesive, which is generally one of the special mortars mentioned. The reinforcing fabric is subsequently laid automatically into the fresh mortar bed. In the next step, the excess adhesive is taken off to achieve a prescribed layer thickness. The boards which have been prepared in this way subsequently pass through a thermal zone to accelerate the curing of the adhesive or adhesive mortar.

The major disadvantage of this automated process is that the plants used for this purpose cannot process support elements having a thickness of less than 10 mm.

The production of fabric-laminated rigid foam supporting elements with small thickness has therefore hitherto not been possible by machine, since the low thicknesses of the unlaminated rigid foam core are insufficiently stiff, as a result of which these thin rigid foam core elements are unsuitable for the machine production process. In the alternative manual production, the laminating fabric is firstly laid onto an outer surface of the rigid foam core elements. A special mortar is subsequently manually trowelled on the fabric and the foam core. As in the machine process too, the fabric is fixed permanently onto the support board by the subsequent curing of the special mortar. After curing of the one-sided fabric lamination, the opposite and unlaminated outer surface is finally, if appropriate, likewise manually reinforced with a fabric.

This manual production of fabric-laminated rigid foam supporting elements having a thin total thickness of less than 10 mm is extremely time-consuming and therefore cost intensive. Furthermore the board quality differs greatly because of the manual process steps.

It was an object of the present invention to provide fabric-reinforced rigid foam supporting elements having a total thickness of less than 10 mm which can be produced low in cost and with high product quality.

This object is achieved by corresponding supporting elements which have been produced completely by machine.

It has surprisingly been found that the rigid foam supporting elements produced as discribed not only fully achieve the objective but even at very low thicknesses they have a stiffness which make them suitable for all common fields of application for rigid foam support elements with thickness of more than 10 mm. In addition, by using the production process of the invention, it is also possible to produce rigid foam support elements in virtually any layer thickness below 10 mm without a serious reject rate of the boards, as a result of which the economics and also the variety of boards are additionally increased.

In a preferred aspect of the rigid foam supporting element claimed, the element is fabric-reinforced on both surfaces. In addition, preference is given to the rigid foam supporting element with a core of foamed polystyrene and/or polyurethane, where extruded cores are especially enabled.

Apart from the rigid foam supporting element, the present invention also encompasses a variant in which the supporting element is closely linked to its production process:

According to this variant of the present invention, the rigid foam supporting element should have been produced by
a) fabric-reinforcing a rigid foam core with a thickness of more than 10 mm on at least one of its surfaces and then,
b) cutting the rigid foam board, which is obtained from process step a) and is fabric-reinforced on at least one side, into individual boards each having a thickness of ≦10 mm,
and, if appropriate,
c) adhesively bonding two of the rigid foam boards obtained from process step b) to one another over the area of surfaces which have not been fabric-reinforced so as to give a rigid foam support element which is fabric-reinforced on at least one outer surface and has a total thickness of less than 10 mm.

In this process, rigid foam cores having a thickness of more than 10 mm are thus used as starting material since they have the stiffness required for fabric reinforcement by machine. According to the invention, rigid foam boards with a thickness of from 10 to 60 mm and in particular of 10, 20, 40 or 50 mm are preferably used in process step a). The fabric lamination can in the case of these boards be carried out either on one side but naturally also on both outer surfaces of the boards. However, one-sided machine lamination is preferred.

The rigid foam boards which have been fabric-laminated in process step a) are subsequently cut by machine over their area to the desired thickness and separated from the support foam core except for a thin foam layer. In process step b), the fabric-reinforced rigid foam board is preferably cut into individual boards which have a thickness of in each case ≦5 mm. This cutting to the desired board thickness is carried out by customary methods of the prior art. For example, reference may at this point be made to a cutting apparatus as described in DE 199 06 225 A1.

The rigid foam boards which are fabric-laminated on at least one side and have been cut to size in process step b) have a thickness of less than 10 mm and in particular ≦5 mm. As a result of the fabric lamination on one side, these relatively thin-walled rigid foam support elements have good stiffness and strength despite a low total thickness.

The cutting procedure in process step b) enables a rigid foam support element which is fabric-reinforced on one outer surface and which has the desired total thickness of <10 mm to be obtained. One side laminated supporting elements which have been produced in this way can, due to their stiffness which has been achieved by the reinforcement, additionally be coated with fabric and mortar by machine on the resulting cut surface in a known manner. This gives rigid foam boards which are laminated on both sides and have been produced entirely by machine.

However, to achieve a defined thickness of less than 10 mm, it is also possible to adhesively bond supporting elements which are laminated on one side and have individual thicknesses of less than 10 mm to one another over their area in an additional process step c) so as to give rigid foam support elements which have a total thickness of <10 mm and are finally fabric-laminated on both opposite outer surfaces.

In this last-mentioned variant, rigid foam boards which are fabric-laminated on one side are joined to one another over their area in an automatic run-through plant in process step c) so as to give a rigid foam board which is fabric-laminated on its two outer surfaces and has the desired total thickness of less than 10 mm.

The variability which has already been indicated to be advantageous above is additionally achieved, within the scope of the present invention, by rigid foam boards which have originated from rigid foam boards having different layer thicknesses being adhesively bonded to one another in process step c).

The present invention is likewise not restricted in respect of the fabric reinforcement or fabric lamination. However, it has been found to be advantageous for the lamination to have been carried out using a synthetic textile and/or a fibreglass fabric in process step a). The sole selection criterion is the required stiffness of the rigid foam boards sought. For this reason, a fibreglass fabric, which is considered to be preferred according to the present invention, is used in most cases.

To fix or adhesively bond the selected fabric, which can naturally also be a mixed form, onto the rigid foam boards, it is possible to use a wide variety of materials. Thus, the fixing of the reinforcing fabric in process step a) should be carried out by adhesive bonding, preferably with the aid of an adhesive. Possible adhesives for this purpose are those based on aqueous dispersions of styrene, acrylate, butadiene, vinyl acetate, vinyl versatate and ethylene, as are solvent-free reactive resins, in particular epoxy resins and polyurethanes. Adhesives based on hydraulically setting but also nonhydraulically setting inorganic binders such as lime, gypsum plaster, water glass, anhydrite and cement are likewise suitable. Hydraulically setting adhesives based on cement are considered to be particularly preferred.

The adhesive bonding provided in process step c) of the fabric-laminated rigid foam boards which have been cut to size in process step b) can likewise be carried out using the above mentioned adhesives. However, aqueous adhesives based on water-soluble polymers such as starch ethers, cellulose ethers, xanthan, alginates and sugar derivatives are also possible. Adhesives based on aqueous polymer dispersions have been found to be particularly suitable.

Finally, the present invention also encompasses the use of the rigid foam supporting element claimed. Possible uses here are, in particular, use as insulation material in building and construction in general and preferably in the interior sector. The rigid foam support element described is particularly suitable for constructions and/or thermal insulation, but also for acoustic insulation.

The advantages of the present invention are demonstrated by the following examples.

### EXAMPLES

### Example 1

A fibreglass fabric was applied by machine in a common manner to a rigid foam board made of extruded rigid polystyrene foam and having areal dimensions of 600 mm×2600 mm and a thickness of 13 mm using a special mortar based on portland cement. After curing of the mortar, the fibreglass-laminated rigid foam board was cut by machine using a hot wire as cutting device to a thickness of 2 mm. Two rigid foam boards which had been obtained in this way and were each fibreglass-laminated on one side were adhesively bonded to one another by machine on the two cut surfaces using an adhesive based on an aqueous styrene-acrylate dispersion. This gave a rigid foam support element which was laminated on both sides with fibreglass fabric and had a total thickness of 4 mm and excellent stiffness in an low cost manner.

### Example 2

A fibreglass fabric was applied by machine in a known manner to each of the two flat sides of a rigid foam board made of extruded rigid polystyrene foam and having areal dimensions of 600 mm×2600 mm and a thickness of 14 mm using a special mortar based on portland cement. After curing of the mortar, the rigid foam board which had been fibreglass-laminated on both sides was parted by machine using a hot wire as cutting device so as to give boards which were each laminated on one side and had individual thicknesses of 8 mm and 6 mm. The rigid foam boards which were obtained in this way and were each fibreglass-laminated on one side were subsequently coated by machine in a common manner with fibreglass fabric and cement mortar on the cut surfaces and cured. This gave rigid foam support elements which were laminated with fibreglass fabric on both sides and had a total thickness of 8 mm and 6 mm in an inexpensive manner.

1-11. (canceled)

12. A fabric-reinforced rigid foam supporting element having a total thickness of <10 mm, produced completely by machine.

13. A rigid foam supporting element according to claim 12, wherein the element is fabric-reinforced on both outer surfaces.

14. A rigid foam supporting element according to claim 12, wherein the element comprises at least one member selected from the group consisting of foamed polystyrene and foamed polyurethane.

15. A rigid foam supporting element according to claim 14, wherein said foamed polystyrene and foamed polyurethane is extruded.

16. A rigid foam supporting element according to claim 12 produced by the process comprising the steps of
a) fabric-reinforcing a rigid foam board having a thickness of >10 mm on at least one outer surface thereof; and subsequently
b) cutting the rigid foam board which is obtained from process step a) and is fabric-reinforced on at least one side into individual boards each having a thickness of <10 mm.

17. A rigid foam supporting element according to claim 16, further comprising the step of
c) adhesively bonding two of the rigid foam boards obtained from process step b) to one another over the area of surfaces which have not been fabric-reinforced so as to give a rigid foam supporting element which is fabric-reinforced on at least one outer surface and has a total thickness of <10 mm.

18. A rigid foam support element according to claim 16, wherein rigid foam boards having a thickness of from 10 to 60 mm been used in process step a).

19. A rigid foam support element according to claim 18, wherein the rigid foam boards have a thickens of 10, 20, 40 or 50 mm.

20. A rigid foam supporting element according to claim 12, wherein the fabric-reinforced rigid foam board is cut into individual boards which have an individual thickness of ≦5 mm in process step b).

21. A rigid foam supporting element according to claim 12, wherein rigid foam boards which have originated from rigid foam boards having different thicknesses are adhesively bonded to one another in the optional process step c).

22. A rigid foam supporting element according to claim 16, wherein the fabric reinforcement in process step a) is conducted using a textile, synthetic or fiberglass fabric.

23. A rigid foam supporting element according to claim 16, wherein the fixing of the reinforcing fabric in process step a) is effected by adhesive bonding with an adhesive.

24. A rigid foam supporting element according to claim 23, wherein the adhesive is selected from the group consisting of adhesive based on an aqueous dispersion of styrene, acrylate, butadiene, vinyl acetate, vinyl versatate, ethylene, or a solvent-free reactive resins and adhesives based on hydraulically or a nonhydraulically setting inorganic binders.

25. A rigid foam supporting element according to claim 17, wherein the adhesive bonding in step c) is conducted with an adhesive selected from the group consisting of an adhesive based on an aqueous dispersion of styrene, acrylate, butadiene, vinyl acetate, vinyl versatate, ethylene and solvent-free reactive resins, an adhesive based on hydraulically or nonhydraulically setting inorganic binder, and aqueous adhesive based on a water-soluble polymer.

26. A building or construction comprising the rigid foam supporting element according to claim 12.

27. A rigid foam supporting element according to claim 24, wherein the adhesive is selected from the group consisting of an aqueous dispersion of an epoxy resin, an aqueous dispersion of polyurethane, or an adhesion dispersion based on at least one member selected from the group consisting of lime, gypsum, plaster, waterglass, anhydrite and cement.

28. A rigid foam supporting element according to claim 25, wherein the adhesion in sep c) is selected form the group consisting of an aqueous dispersion of an epoxy resin, an aqueous dispersion of polyurethane, or an adhesion dispersion based on at least one member selected from the group consisting of lime, gypsum, plaster, waterglass, anhydrite and cement, or aqueous adhesive containing at least one of a starch ether, a cellulose ether, xanthan, alginate or a sugar derivative

29. A method comprising:
a) fabric-reinforcing a rigid foam board having a thickness of greater than 10 mm on at least one outer surface thereof; and subsequently
b) b) cutting the rigid foam board which is obtained from process step a) and is fabric-reinforced on at least one side into individual boards each having a thickness of ≦10 mm, to produce a fabric-reinforced rigid foam supporting element having a total thickness of less than 10 mm.

30. The method of claim 29, further comprising the step of
c) adhesively bonding two of the rigid foam boards obtained from process step b) to one another over the area of surfaces which have not been fabric-reinforced so as to give a rigid foam supporting element which is fabric-reinforced on at least one outer surface and has a total thickness of <10 mm.
